(19) United States
(12) Patent Application Publication
(10) Pub. No.: US 2008/0308003 A1
(43) Pub. Date: Dec. 18, 2008

(54) UV inkjet resist

(76) Inventors: Andrew M. Krol, Bristol, CT (US); John Ganjei, Southbury, CT (US); David Sawoska, Watertown, CT (US)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 11/818,185

(22) Filed: Jun. 13, 2007

(51) Int. Cl. C09D 11/02

(52) U.S. Cl. 106/31.43; 106/31.13; 106/31.27

(57) ABSTRACT

A UV curable, etch-resistant ink composition for ink jet printing of variable information on printed circuit boards and for printing the circuit boards themselves. The ink composition of the invention includes a novel thermal stabilizer for preventing the ink composition from hardening and gelling in the print head when heated.

### FIELD OF THE INVENTION

The present invention is directed to a UV inkjet resist that has increased thermal stability and substantially resists gelling and hardening in an inkjet printhead.

### BACKGROUND OF THE INVENTION

Resist patterns have previously been formed on printed circuit boards using screen printing methods as is well known in the art. Resist patterns have also been formed by a process which comprises using a copper foil laminate, applying a photosensitive film thereto, exposing the photosensitive film to light through a photographic negative, and removing the unexposed portion, followed by etching away any unnecessary copper foil part not under the circuit pattern, and removing the photosensitive film to form a printed circuit on the insulated laminated plate. However, the photosensitive film used in the process is fairly thick, which makes it difficult to uniformly laminate the photosensitive film on the surface of the copper foil.

More recently, ink jet printing and ink compositions which permit ink to be jetted from an ink jet printer have been developed and offer a means for preparing circuit boards of increasing density and printing variable information on circuit boards.

Ink jet printing is a non-impact technique for projecting droplets of ink onto a substrate. There are two major categories of ink jet printing, “prop-On-Demand” ink jet and “Continuous” ink jet. In prop-On-Demand ink jet technology, the ink is typically stored in a reservoir and delivered to a nozzle in the print head of the printer. A means is provided to force a single drop of ink out of the nozzle whenever it is needed to print a single spot on the printed medium. In Continuous ink jet technology, a conducting ink is supplied under pressure to an ink nozzle and forced out through a small orifice. The ink breaks up into a continuous series of drops and a voltage is applied between a charge electrode and the stream of drops. By varying the charge on individual drops, the desired pattern can be printed.

U.S. Pat. No. 4,668,533 to Miller, the subject matter of which is herein incorporated by reference in its entirety, describes the preparation of printed circuit boards using an ink jet printer to deposit a water-based ink containing a metal onto a substrate in a predetermined pattern, and thereafter electrolessly depositing a second metal substantially congruent to the first metal. The Miller patent describes various other prior art patents and publications that use ink jet printing technology during the production of printed circuit boards.

While various methods have been suggested for using ink jet printing technology during the production of printed circuit boards a drawback to this technology is the tendency for the ink composition to gel and harden in the printhead when the composition is heated. Thus, further improvements to UV curable, etch-resistant ink compositions are necessary to produce ink compositions that have better thermal stability and substantially resist gellation in the ink jet print head as compared to ink compositions of the prior art.

To that end, the present invention suggests an improved UV curable ink composition that includes a beneficial thermal stability agent to prevent the ink from gelling in the inkjet print head when heated. The inventors of the present invention have determined that ink jet compositions containing this additive have greater thermal stability and resist gelling and hardening in the inkjet print head as compared to ink compositions of the prior art.

### SUMMARY OF THE INVENTION

It is an object of the present invention to provide an improved UV curable ink jet ink composition that has improved thermal stability.

It is another object of the present invention to provide an improved UV curable ink jet ink composition that substantially resists gellation and hardening in the ink jet print head when heated.

To that end, the present invention relates to a UV ink jet ink composition comprising:

a) at least one photopolymerizable unsaturated compound;

b) a reactive diluent;

c) at least one photoinitiator, and

d) a thermal stabilizer.

In a preferred embodiment, the thermal stabilizer is tris(n-nitroso-n-phenylhydroxylamine)aluminum salt.

The inventors have found that the addition of the thermal stabilizer of the invention provides a UV ink jet ink composition that has increased thermal stability and substantially resists gelling in the ink jet print head as compared to compositions of the prior art.

Other objects, features and advantages of the invention will hereinafter become apparent from the following description.

### DETAILED DESCRIPTION OF THE INVENTION

The present invention relates to an improved UV inkjet resist that has increased thermal stability and resists gelling and hardening in the print head when heated

In one embodiment, the UV inkjet composition of the invention comprises:

a) at least one photopolymerizable unsaturated compound;

b) a reactive diluent;

c) at least one photoinitiator, and

d) a thermal stabilizer.

In a preferred embodiment, a variety of photopolymerizable unsaturated compounds that are usable in free radical polymerization may be used in the composition of the invention. Preferably, the ink composition contains about 45-55 percent by weight, based on the total weight of the composition, of the photopolymerizable unsaturated compounds.

The at least one photopolymerizable unsaturated compound, which may include compounds that provide enhanced cross-linking, is useful in compositions of the invention. Examples of these compounds include 1,4-butanediol diacrylate, 1,4-butanediol dimethacrylate, 1,6-hexamethylene glycol diacrylate, 1,6-hexamethylene dimethacrylate, neopentyl glycol diacrylate, neopentyl glycol dimethacrylate, trimethylol propane triacrylate, trimethylol propane trimethacrylate, pentaerythritol triacrylate, pentaerythritol trimethacrylate, pentaerythritol tetraacrylate, pentaerythritol tetramethacrylate, dipentaerythritol hexaacrylate, dipentaerythritol hexamethacrylate, triethylene glycol triacrylate, triethylene glycol trimethacrylate, urethane acrylate, and urethane methacrylates. In one embodiment, a fast curing monomer, such as 3 mole ethoxylated trimethylolpropane triacrylate (Tradename SR-454, available from Sartomer Company, Inc.) is used to provide enhanced cross-linking. This compound may be used in the composition in an amount of about 8.0-12.0 percent by weight, based on the total weight of the composition.

In addition, a low-volatility, low viscosity monomer such as tripropylene glycol diacrylate (Tradename SR-306, available from Sartomer Company, Inc.) may also be used in the composition of the invention, for example at about 20.0-30.0 percent by weight, based on the total weight of the composition.

Also usable in the present invention is a monofunctional monomer that contains a cyclic group, such as tetrahydrofurfuryl acrylate (Tradename SR-285, available from Sartomer Company, Inc.) that promotes adhesion to numerous substrates. The amount of such monofunctional monomer in the composition is typically between about 15.0-20.0 percent by weight based on the total weight of the composition.

The present invention also preferably contains a reactive diluent, which is preferably an acrylate reactive diluent. The reactive diluent has functional groups which are capable of polymerizing when the reactive diluent is exposed to actinic radiation at an energy or wavelength level which is capable of inducing crosslinking or chain extension in the photopolymerizable polymer. Preferably, the reactive diluent system comprises a monomer or monomers having an acrylate or N-vinyl functionality and a C₄-C₂₀ alkyl or polyether moiety. Examples of such reactive diluents include hexylacrylate, 2-ethylhexylacrylate, isobornyl acrylate, decylacrylate, laurylacrylate, stearylacrylate, ethoxyethoxyethylacrylate, laurylvinylether, 2-ethylhexylvinyl ether, N-vinyl formamide, isodecyl acrylate, isooctyl acrylate, N-vinyl-caprolactam, N-vinylpyrrolidone, tetraethylene glycol diacrylate, hexanediol diacrylate, ethoxylated trimethylol propane triacrylate and the like. Suitable reactive diluents are commercially available from Sartomer Co., Inc., Henkel Corp., Radcure Specialties, among others. A preferred reactive diluent for use in compositions of the invention is isobornyl acrylate (Tradename SR506D, available from Sartomer Company, Inc., at about 15.0-25.0 percent by weight based on the total weight of the composition.

Compositions of the invention also preferably contain an adhesion promoter, which in one embodiment is an acidic adhesion promoter such as Photomer® 4703, available from Cognis Corporation. If used, the adhesion promoter may be present in the composition in an amount of about 10.0-20.0 percent by weight, based on the total weight of the composition.

Compositions of the present invention also contain at least one photoinitiator. Many such materials are well known to the prior art. The photoinitiator can be any compound that produces a free radical on exposure to radiation such as ultraviolet or visible radiation and thereby initiates a polymerization reaction. Examples of some suitable photoinitiators include anthraquinone and substituted anthraquinones such as alkyl substituted or halo substituted anthraquinones including 2-tert-butylanthraquinone, 1-chloro-anthraquinone, p-chloroanthraquinone, 2-methylanthraquinone, 2-ethylanthraquinone, octamethylanthraquinone and 2-amylanthraquinone; other substituted or unsubstituted polynuclear quinones including 1,4-naphthoquinone, 9,10-phenanthraquinone, 1,2-benzanthraquinone, 2,3-benzanthraquinone, 2-methyl-1,4-naphthoquinone, 2,3-dichloronaphthoquinone, 1,4-dimethylanthraquinone, 2,3-dimethylanthraquinone, 2-phenylanthraquinone, 2,3-diphenylanthraquinone, 3-chloro-2-methylanthraquinone, retenequinone, 7,8,9,10-tetra-hydronaphthaacenequinone, 1,2,3,4-tetrahydrobenzantracene-7,2-dione; acetophones such as acetophone, 2,2-dimethoxy-2-phenylacetophone, 2,2-diethoxy-2-phenylacetophone, 1,1-dichloroacetophone, 1-hydroxycyclohexylphenylketone, and 2-methyl-1-(4-methylthio)phenyl-2-morpholin-propan-1-one; thioxanthones such as 2-methylthioxanthone, 2-decylthioxanthone, 2-dodecylthioxanthone (DTX), 2-isopropylthioxanthone, 2,4-dimethylhioxanthone, 2,4-diethylthioxanthone, 2-chlorothioxanthone, and 2,4-diisopropylthioxanthone; and ketals such as acetophone dimethylketal and benzil dimethylketal; benzoins and benzoin alkyl ethers such as benzoin, benzyl, benzoin methyl ether, and benzoin isopropyl ether, and benzoin isobutyl ether; azo compounds such as azobisisovaleronitrile; and benzophones such as benzophenone, methyl benzophenone, 4,4′-dichlorobenzophenone, 4,4′-bisdiethylaminobenzophenone, Michler's ketone and xanthones. If desired, mixtures of photoinitiators may be used.

In a preferred embodiment, a combination of Irgacure® 907 (available from Ciba Specialty Chemicals) and Darocur® ITX, which is a mixture of 2-isopropylthioxanthone and 4-isopropylthioxanthone (available from Ciba Specialty Chemicals) may be used in compositions of the invention. Darocur® ITX is a type II photoinitiator that is used as an efficient sensitizer in combination with type I photoinitiators absorbing at shorter wavelengths, such as Irgacure® 907. In one embodiment, about 0.5 to 2.0% Darocur® ITX is used together with about 2.0 to 6.0% Irgacure® 907. In addition, in a preferred embodiment, the composition may further contain an additional photoinitiator such as Esacure® KB1 (available from Sartomer Company, Inc.), which is a crystalline form of benzildimethyl ketal, which has a fast cure response and a good through cure.

Finally, compositions of the invention include a thermal stabilizer which in a preferred embodiment is tris(n-nitroso-n-phenylhydroxylamine)aluminum salt (Trade Name FirstCure NPAL™, available from First Chemical). The preferred thermal stabilizer is added to the composition to prevent the composition from gelling and hardening in the print head when heated. The inventors of the present invention have found that other thermal stabilizers such as hydroquinone, methylhydroquinone and di-tert-butyl methyl phenol do not perform as well because they do not prevent the composition from gelling and hardening. NPAL™ is typically used in the composition in amount of about 0.05 to 1.0 percent by weight, based on the total weight of the composition, and is more preferably used in the composition in an amount of about 0.25 to 0.50 percent by weight based on the total weight of the composition.

If desired, compositions of the present invention may include photosensitizers. The photosensitizers increase sensitivity by absorbing light of the wavelengths to which it best responds. Many such materials are well known to the prior art. If used, they are typically present in the composition in amounts ranging from about 0.25% to about 5%. Examples of some suitable photosensitizers include all of the photoinitiators mentioned above; halogen-type sensitizers such as carbontetrachloride, bromoform and carbontribromide; benzoic esters such as ethyl-4-dimethylaminobenzoate and 2-(dimethylamino)ethylbenzoate; tertiary amines such as triethyl amine and triethanol amine; benzotriazole, benzoin, chloranil, benzil, diacetyl, 5-nitrosalicylaldehyde, 2,4-dinitrotoluene.

Photostabilizers may also be employed in the compositions of the present invention to prevent polymerization of the compositions when exposed to natural light. In addition, the ink composition of the present invention may optionally contain a corrosion inhibitor in sufficient quantity to inhibit corrosion of metal placed in contact with the ink, without adversely affecting the printing characteristics of the ink.

The present invention may also comprise other additives, which may be any substance that can enhance the ink with regard to (i) improved solubility of other components, (ii) improved print quality, (iii) improved adhesion of the ink to the media, and (iv) control of wetting characteristics, which may be related to such properties as surface tension and viscosity, among other properties.

In addition, other optional additives such as dispersing agents may be present. If present, they may be present in the ink in amounts of from about 0.01 to about 20 percent by weight. Further, plasticizers and the like, may be present.

The ink of this invention can be used as a clear ink without the addition of a colorant. If the ink is desired to be visible (for example, to make sure this ink after curing and etching was completely stripped) colorants can be added. Typically, if colorants are present in the ink, they are used in an amount ranging from about 0.1% to 4 percent by weight, based on the total weight of the composition. Colorants which may be used in compositions of the invention include Morfast black A, Morfast black 101, Morfast red 102, and Morfast yellow 102, all available from Morton International. Also, Hektoblack X-2 (from BASF) can be used. In addition, Milliken Chemicals offers Milliken blue A45-1, Milliken red A45-2, and Milliken yellow A45-3. Finally, crystal violet (available form various sources) may be used as the colorant in compositions of the invention.

While not essential to the practice of the present invention, the ink composition of this invention can also be formulated to include evaporation retardants, also known as humectants. These compounds prevent the ink jet orifice from drying or crusting. Typical classes of humectants include glycol ethers and glycol esters or combinations thereof. Specific examples are compounds such as ethylene glycol and propylene glycol methyl ether.

The formulated jet inks of the present invention will exhibit the following characteristics: (1) a viscosity from about 10 to about 50 centipoises (cps) at 25° C., (2) a surface tension below 28 dynes/cm. Electrolytes can be added to adjust the specific resistivity of the ink. Usable electrolytes include dimethylamine hydrochloride and hydroxylamine hydrochloride. The modifications of the principal components of the ink compositions, to achieve the desired operational characteristics is well within the skill in the art.

The viscosity of the jet ink composition is generally from about 10 to about 50 centipoise. Various, known viscosity modifying agents may be added, in addition to any acrylate resins capable of lowering viscosity, as needed to adjust the viscosity of any given ink formulation. Additionally, the jet ink composition should enable printed images with sufficient flexibility to prevent cracking or creasing.

The compositions of this invention can be applied to a wide range of non-porous substrates, e.g. coated paper, metal, wood, metals, ceramics, plastics or glass. However, the invention is of especial use in forming a pattern on a copper clad board, such as variable information or the circuit itself, and then etching the board to obtain the variable information or printed circuit.

The following examples are illustrative of the invention but should not be taken as limiting:

### EXAMPLES

A product formulation was prepared by mixing the following ingredients together:

| Weight | |
|---|---|
| Percent | Ingredient |
| 10.43 wt % | ethoxylated (3) trimethylolpropane triacrylate (Trade Name |
| | SR-454, available from Sartomer) |
| 24.57 wt % | tripropylene glycol diacrylate (Trade Name SR-306, |
| | available from Sartomer) |
| 21.00 wt % | isobornyl acrylate (Trade Name SR-506, available from |
| | Sartomer) |
| 17.16 wt % | tetrahydrofurfuryl acrulate (Trade Name SR-285, available |
| | from Sartomer) |
| 15.00 wt % | acid adhesion promoter (Trade Name Photomer 4703, |
| | available from Cognis) |
| 1.00 wt % | tris(n-nitroso-n-phenylhydroxylamine) aluminum salt |
| | (Trade Name FirstCure NPAL, available from First |
| | Chemical) |
| 1.74 wt % | benzyl diemethyl ketal (Trade Name KB-1, available from |
| | Sartomer) |
| 6.96 wt % | photoinintiator (Tradename Irgacure ® 907, available |
| | from Ciba Specialty Chemicals) |
| 1.74 wt % | type II photoinitiator (Darocur ® ITX, available from Ciba |
| | Specialty Chemicals) |
| 0.40 wt % | crystal violet |

The amount of NPAL was varied in the composition and other thermal stabilizers were also used as set forth in Tables 2 and 3.

In particular, an oven stability test was performed on compositions containing various thermal stabilizers, including hydroquinone (HQ), methylhydroquinone (MeHQ), di-ter-butyl methyl phenol (BHT) and the NPAL of the present invention. The results of the comparison study are provided below to show an accelerated six-month shelf life of a UV curable ink composition containing various thermal stabilizers. Table 2 provides results with head space in the container and Table 3 provides results with no head space in the container to simulate the print head.

As seen in Table 2, hydroquinone performed adequately at concentrations above 0.10% and below 0.50% but gelled after day 4 for a concentration of 0.05%. and 3. However, methylhydroquinone and di-ter-butyl methyl phenol did not perform adequately at any concentration studied. NPAL performed adequately for all but the concentration of 0.05%.

TABLE 2
Results from OVEN Stability Test (with head space in container) Accelerated
Six-Month Shelf Life

| | Conc. | Day 1 | Day 2 | Day 3 | Day 4 | Day 5 | Day 6 | Day 7 |
|---|---|---|---|---|---|---|---|---|
| Stabilizer | % | 60° C. | 60° C. | 60° C. | 60° C. | 60° C. | 60° C. | 60° C. |
| HQ | 0.50% | OK | OK | OK | OK | OK | OK | OK |
| HQ | 0.25% | OK | OK | OK | OK | OK | OK | OK |
| HQ | 0.10% | OK | OK | OK | OK | OK | OK | OK |
| HQ | 0.05% | OK | OK | OK | Jelled | | | |
| BHT | 2.00% | OK | OK | OK | OK | OK | OK | Jelled |
| BHT | 1.50% | OK | OK | OK | OK | OK | OK | Jelled |
| BHT | 1.00% | OK | OK | OK | OK | Jelled | | |
| BHT | 0.50% | OK | OK | OK | Jelled | | | |
| BHT | 0.25% | OK | Jelled | | | | | |
| BHT | 0.10% | Jelled | | | | | | |
| BHT | 0.05% | Jelled | | | | | | |
| MeHQ | 2.00% | OK | OK | OK | Jelled | | | |
| MeHQ | 1.50% | OK | OK | OK | Jelled | | | |
| MeHQ | 1.00% | OK | OK | OK | Jelled | | | |
| MeHQ | 0.50% | OK | OK | OK | Jelled | | | |
| MeHQ | 0.25% | OK | OK | Jelled | | | | |
| MeHQ | 0.10% | OK | Jelled | | | | | |
| MeHQ | 0.05% | Jelled | | | | | | |
| NPAL | 0.50% | OK | OK | OK | OK | OK | OK | OK |
| NPAL | 0.25% | OK | OK | OK | OK | OK | OK | OK |
| NPAL | 0.10% | OK | OK | OK | OK | OK | OK | OK |
| NPAL | 0.05% | OK | OK | OK | OK | OK | Jelled | |

Table 3 shows the comparative results of the various thermal stabilizers in a container with no head space to simulate the action of an ink jet print head. As is readily seen, NPAL performed well at concentrations between about 0.25% and 0.50% while hydroquinone did not perform well at any concentration. These results demonstrate that NPAL substantially prevents the UV curable ink composition from gelling as compared with compositions containing other thermal stabilizers described in the prior art.

TABLE 3
Results from OVEN Stability Test (with no head space in container to simulate
print head)

| | Conc. | Day 1 | Day 2 | Day 3 | Day 4 | Day 5 | Day 6 | Day 7 |
|---|---|---|---|---|---|---|---|---|
| Stabilizer | % | 60° C. | 60° C. | 60° C. | 60° C. | 60° C. | 60° C. | 60° C. |
| NPAL | 0.50% | OK | OK | OK | OK | OK | OK | OK |
| NPAL | 0.25% | OK | OK | OK | OK | OK | OK | OK |
| NPAL | 0.10% | OK | OK | OK | OK | Jelled | | |
| NPAL | 0.05% | OK | OK | Jelled | | | | |
| HQ | 0.50% | OK | OK | Jelled | | | | |
| HQ | 0.25% | OK | OK | Jelled | | | | |
| HQ | 0.10% | OK | Jelled | | | | | |
| HQ | 0.05% | Jelled | | | | | | |

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying tables shall be interpreted as illustrative and not in a limiting sense.

What is claimed is:

1. An ink composition for use in ink jet printing comprising:
a) at least one photopolymerizable unsaturated compound;
b) a reactive diluent;
c) at least one photoinitiator, and
d) a thermal stabilizer that is capable of preventing the ink composition from gelling and hardening when the composition is heated until exposed to U.V. radiation.

2. The ink composition according to claim 1, wherein the thermal stabilizer comprises tris(n-nitroso-n-phenylhydroxylamine)aluminum salt.

3. The ink composition according to claim 1, wherein the thermal stabilizer is present in the composition at an amount of about 0.05 to 1.0 percent by weight, based on the total weight of the composition.

4. The ink composition according to claim 3, wherein the thermal stabilizer is present in the composition at an amount of about 0.25 and 1.0 percent by weight, based on the total weight of the composition.

5. The ink composition according to claim 1, wherein the at least one photopolymerizable unsaturated compound is present in the composition at an amount of about 45 to 55 percent by weight, based on the total weight of the composition.

6. The ink composition according to claim 1, wherein the reactive diluent comprises an acrylate reactive diluent.

7. The ink composition according to claim 6, wherein the acrylate reactive diluent is isobornyl acrylate.

8. The ink composition according to claim 6, wherein the reactive diluent is present in the ink composition at an amount of about 15.0 to about 25.0 percent by weight, based on the total weight of the composition.

9. The ink composition according to claim 1, wherein the at least one photoinitiator comprises a mixture of photoinitiators.

10. The ink composition according to claim 1, further comprising an adhesion promoter capable of promoting adhesion to metal substrates.

11. The ink composition according to claim 10, wherein the adhesion promoter is present in the ink composition at an amount of about 10.0 to about 20.0 percent by weight, based on the total weight of the composition.

12. The ink composition according to claim 1, wherein the ink further comprises a colorant.

13. The ink composition according to claim 12, wherein the colorant is crystal violet.

14. An ink composition for use in ink jet printing comprising tris(n-nitro-n-phenylhydroxylamine) or a salt of the foregoing amine.

15. An ink composition according to claim 14 wherein the concentration of the amine or salt theory is from about 0.05 to 1.0 percent by weight of the ink composition.
